(19) United States
(12) Patent Application Publication
(10) Pub. No.: US 2021/0386044 A1
(43) Pub. Date: Dec. 16, 2021

(54) Artificial Fishing Lure with a Damper Bar

(71) Applicant: Dominion Lures, Inc., Mission Viejo, CA (US)

(72) Inventor: George J. Coniglio, Mission Viejo, CA (US)

(73) Assignee: Dominion Lures, Inc., Mission Viejo, CA (US)

(21) Appl. No.: 16/898,933

(22) Filed: Jun. 11, 2020

(51) Int. Cl. A01K 85/18

(52) U.S. Cl. CPC A01K 85/18

(57) ABSTRACT

A multi-segmented, soft-bodied, artificial fishing lure or swim bait with a natural profile includes one or more damper elements in the joint between the first and second body segments to control the relative movement between the first and second body segments. The artificial fishing lure may also include one or more optional control planes.

### FIELD OF THE INVENTIONS

The inventions described below relate to the field of fishing lures and more specifically to realistic fishing lures that accurately simulate live, healthy, feeding baitfish.

### BACKGROUND OF THE INVENTIONS

Artificial fishing lures such as swim baits attempt to simulate baitfish and to stimulate a strike response from gamefish. The swim bait has become extremely popular with game fisherman. These devices attempt to emulate the look and motion of smaller swimming fish and other creatures, attracting larger game fish to the hook and capture. Swim baits often closely resemble a shad, minnow, bluegill or any fish in size, shape, and color. The body is segmented in sections to allow it to move back and forth through the water.

Conventional soft plastic swim baits do not perform natural swimming or feeding motions on their own when compared to the live bait fish the lures are simulating. The problems with conventional swim baits are: 1) an unnatural lateral, side to side head wobble producing a wide lateral arc in the front of the lure, this motion is more of a snake like action than of a natural baitfish; 2) an exaggerated head wobble produces the same snakelike, exaggerated, lateral, side to side, wide lateral arc in the tail, similar to what is seen in the head; 3) the swim bait rolls with a longer/wider unnatural rocking about the longitudinal axis, a natural baitfish swims with a slight body roll; 4) the swim bait is unstable during faster retrieves or trolls spinning and rotating about both longitudinal and vertical axis' due to the exaggerated head arc, tail arc and body roll; 5) the swim bait does not swim down or dive downward naturally or glide with an upright orientation. In most cases, when the retrieve or troll is stopped, a conventional swim bait's tail does not beat or move as the bait sinks down toward the bottom, instead, the swim bait just tumbles and sinks.

Many conventional swim bait lures modify the natural, organic look of baitfish to provide twist, curl, paddle, or vortex tails and other visible non-lifelike extensions to generate motion in the lure or to simulate organic fish fins. Often the generated motion of these extensions generate erratic and unnatural motions and they do not look real. In addition, there is some variation in the weight and balance of conventional lures leading to inconsistent performance between two swim baits from the same package.

The fins and shape of living fish enable them to move through the water and feed with very little gross motion as is generated when retrieving many conventional lures. In addition, living baitfish are generally stable in the water and maintain an upright orientation when moving slowly through the water which is very different from many conventional lures that lean and bob in unnatural orientations when they are not being actively retrieved or allowed to sink or rest on the bottom.

### SUMMARY

The devices and methods described below provide for an artificial fishing lure or swim bait with a natural profile that is stable in the water, and demonstrates realistic motions in a range of retrieve speeds and even when allowed to sink or work along the bottom. The artificial fishing lure is a soft body multi-segment swim bait with one or more damping elements such as pins, bars or bumpers inserted through, molded or otherwise formed into one or more of the joints between adjacent body segments to limit or control the lateral movement of adjacent lure body segments relative to each other.

This application incorporates by reference Coniglio, et al., Artificial Fishing Lure, U.S. Pat. No. 9,179,656 (Nov. 10, 2015), Coniglio, et al., Artificial Fishing Lure, U.S. Pat. No. 9,572,332 (Feb. 21, 2017), Coniglio, et al., Artificial Fishing Lure, U.S. Pat. No. 9,572,332 (Feb. 21, 2017), Coniglio, et al., Artificial Fishing Lure, U.S. Pat. No. 9,609,853 (Apr. 4, 2017) and Coniglio, et al., Artificial Fishing Lure, U.S. Pat. No. 9,615,553 (Apr. 11, 2017).

### BRIEF DESCRIPTION OF THE DRAWINGS

FIG. 1 is a side view of a multi-segment soft-bodied fishing lure with control planes inserted.

FIG. 2 is a side view of a multi-segment soft-bodied fishing lure illustrating the control planes and weight and hook.

FIG. 3 is a top view of the fishing lure of FIG. 2.

FIG. 4 is a bottom view of the fishing lure of FIG. 2.

FIG. 5 is a front view of the fishing lure of FIG. 2.

FIG. 6 is a cross section view of the first segment of the fishing lure of FIG. 2 taken along A-A.

FIG. 7 is a cross section view of the second segment of the fishing lure of FIG. 2 taken along B-B.

FIG. 8 is a cross section view of the tail segment of the fishing lure of FIG. 2 taken along C-c.

FIG. 9 is a top view of a fishing lure with an alternate damper bar.

FIG. 10 is a side view of the fishing lure with a plurality of damper elements.

FIG. 11 is a top view of a fishing lure with damper bumpers.

FIG. 12 is a top view of a fishing lure with a damping joint between the first and second body segments.

### DETAILED DESCRIPTION OF THE INVENTIONS

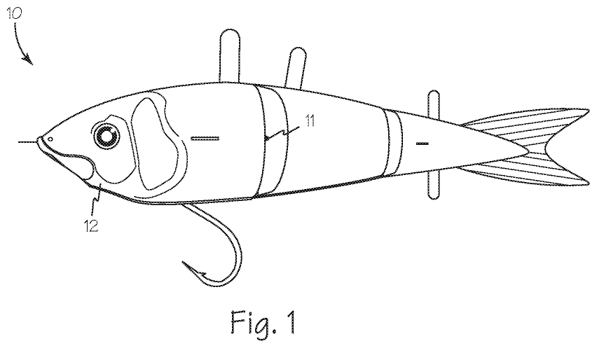

FIG. 1 illustrates lure or swim bait 10 with realistic and adjustable swimming performance generated by the interaction of the multi-segment, soft body 12, one or more damper elements such damper pin 11. Additionally one or more optional control planes may be included in each body segment.

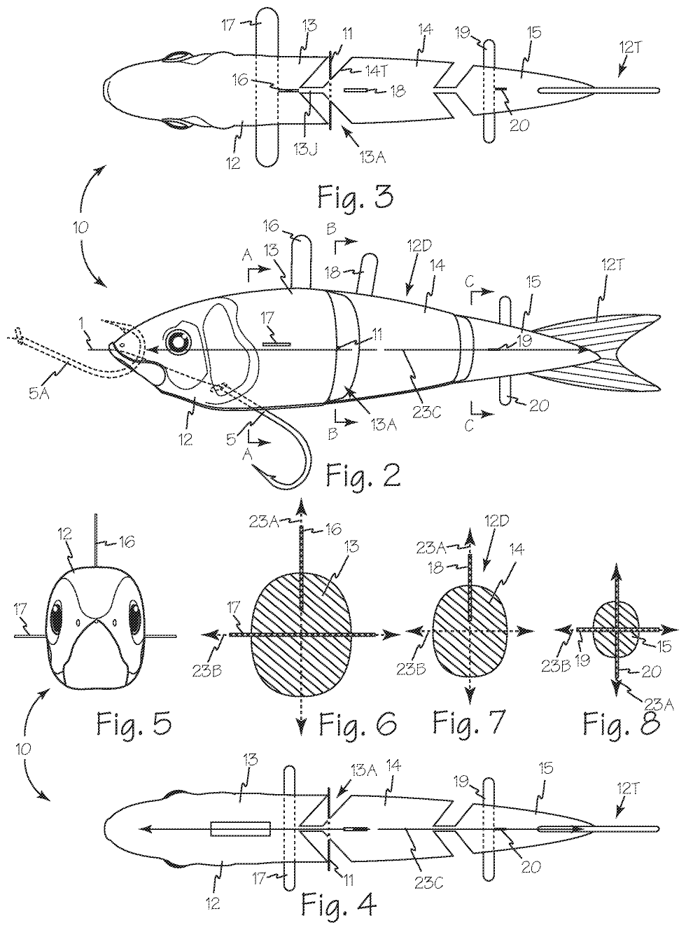

Lure or swim bait 10 of FIGS. 2, 3, 4, 5, 6, 7 and 8 has a soft, multi-segmented body 12 having first, head or front segment 13, second or middle segment 14 and a third or tail segment 15 with a realistic looking tail 12T.

Restriction of lateral/side to side swing movement between the first body segment 13 and second body segment 14 is controlled by the presence of insertion of one or more damper elements in joint 13A between the first body segment 13 and second body segment 14. Damping elements may have any suitable configuration such as a pin, bar, plane or a molded in bumper such as bumper 8A and 8B, illustrated in FIG. 11, in between the first segment and the second segment in a multi-segmented artificial fishing lure or swimbait 10 as illustrated in FIGS. 1, 2, 3, 4, 9, 10 and 11. The damper pin, bar or plane is inserted into the second or following segment just behind the flex joint 13J parallel to the horizontal axis 23B and perpendicular to the longitudinal axis 23C of the artificial fishing lure. The insertion point of a single damper element such as damper pin 11 is at or near the vertical midpoint of the taper 14T extending into the second or following segment such as the second segment 14 as illustrated in FIG. 2.

Alternatively, two or more damper elements such as flexible damper bars 9A and 9B of FIG. 10 may be inserted above and below the vertical midpoint produce all the same desired effects of a single relatively stiff damper element.

In general, the placement of the one or more damper elements determines movement restriction: more forward damper elements restrict motion to a greater degree than more rearward placements. The forward placement limit is up to actual contact with the edges of the body of the swim baits leading segment. This placement restricts the swing/arc of the following segment to a higher degree than placements farther toward the rear.

Damper elements placement flush with the edge of the leading segment body such as damper bar 11 in FIGS. 1, 2, 3 and 4, would allow for limited swing/lateral movement between the adjacent body segments if everything was rigid meaning no flex in the one or more damper elements and no flex at the contact point in the sides of the body of the swim bait in the leading segment and no flex in and around the soft plastic where the one or more damper elements are located. Progressively rearward placements of the one or more damper elements would generate an increase in play/lateral swing.

Since there is some flex in the actual damper elements and some flex in the body sides of the leading segment of the artificial fishing lure where the damper elements are contacting it; and some flex in the plastic in the area around the insertion point of the damper elements in the taper of the following segment near the leading joint. The total lateral swing movement is a function to the combination of the above listed flexibilities. The listed flexibilities work together, creating a spring action thru the one or more damper elements that returns energy to both the leading and following segments returning them to a neutral or rest position. This return to center propensity is also desirable because it creates more glide or coast in that it returns the swimbait to a more streamlined configuration instead of folding up upon itself as it would with more flex in the segment joint. Stiffer damper elements with less flex or springiness deceases tail arc greater relative to a damper elements that are less stiff placed in an identical insertion position. A rigid bar or plane still produces desirable results due to the flexibilities within the lure body in and around the bar's insertion point and where it contacts the sides of the body on the leading segment as illustrated in FIGS. 1, 2, 3 and 4. This reduction of movement in the following segment is transferred down the line to reduce tail arc and increase tail beat frequency in the subsequent segments of the swim bait. This movement restriction more closely duplicates the tail arc, and tail beat frequency produced by a natural appearing baitfish when swimming at higher speeds.

The benefits of incorporating one or more damping elements into an artificial fishing lure is dependent on the material that comprises the fishing lure. The use of Thermoplastic elastomers (TPE) are suitable for artificial fishing lures with damping elements due to the greater elasticity, tensile strength and shore hardness of TPE. Conventional plastics may also be used but with varying degrees of success.

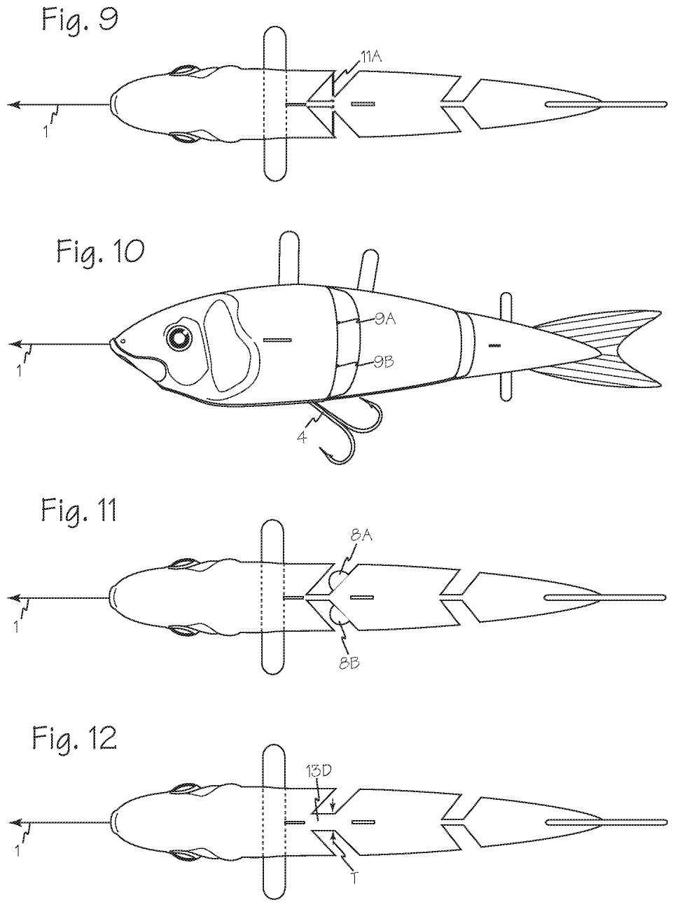

Alternatively, a damper element such as damper bar 11A may be inserted into joint space 13A as illustrated in FIG. 9. Damper bar 11A is shorter than damper bar 11 and thus may be moved closer to the first body segment 13 than damper bar 11.

In another alternative, artificial fishing lure 10 may be configured with a damping joint 13D as illustrated in FIG. 12. The thickness T of damping joint 13D is thicker that the thickness of joint 13J illustrated in FIGS. 2, 3 and 4. The thicker joint similarly damps the relative motion between first body segment 13 and second body segment 14. The damping elements discussed above may also be implemented between any two adjacent body segments.

One or more optional control planes may be frictionally secured in each body segment such as segments 13, 14 or 15 with all the control planes generally coplanar with horizontal axis 23C. For example, first body segment 13 includes front vertical control plane 16 and front horizontal control plane 17. Control planes such as control planes 16 and 17 are generally stiff, clear plastic and may extend from one surface of body 12 or they may extend completely through the body as shown. Any suitable plastic may be selected for control planes, however they should be selected of a material that is generally invisible to fish in the water. Any suitable tool such as a narrow blade knife, razor blade or sharpened piece of plastic may be used to create a slot or opening to accommodate a control plane. The control planes are not sized, shaped or located to simulate the appearance of any natural appendages of any water creature.

Second or middle body segment 14 includes a middle, dorsal control plane 18 which generally extends from top or dorsal surface 12D of the body although any other suitable orientation may be used. Third or tail segment 15 includes first and second control planes 19 and 20. between vertical and horizontal may be used to generate swimming motions of a crippled baitfish.

Properly placed and aligned control planes such as planes 16, 17, 18, 19 and 20 function to change the dynamic forces exerted on a swim bait by the water and the fishing line 1 enabling the lure to achieve desirable, natural swimming motions. To generate natural swimming motions at a range of retrieve speeds as well as when sinking, a segmented, straight tailed, soft polymer or plastic swim bait needs one or more control surfaces to limit unnatural movement in its front and middle segment/sections(s) and one or more control surfaces to enhance and control the movement in its tail segment/section(s). The generally stiff and clear control planes such as planes 16, 17, 18, 19 and 20 provide controlled force to the lure body whether the control plane ends are rounded, squared, diamond, rhombus shaped or even forked as illustrated. Rounded control planes such as control planes 19 and 20 are preferred because there is not a corner or sharp edge to cut or nick the line during the cast or retrieve and rounded control planes shed weeds best. Positioning of a hook such as hooks 4, 5 or 5A and any suitable weight such as weight 2 in front segment 13 stabilizes the lure. Any suitable placement location may be used for hooks 4, 5 or 5A. Two alternate configurations are illustrated in FIG. 2.

Generally, control planes 16, 17, 18 limit back and forth, lateral head wobble, limit vertical roll, twist and rocking, and provide overall stability. Tail control surfaces 19 and 20 control movement to the tail segment/section and add stability. Often, additional tail movement stimulation is required due to the limiting of forces/movements by control planes 16, 17, 18 in the front and middle sections which tend to reduce desired tail movements. Tail control surfaces 19 and 20 may oriented at about 45 degrees from vertical and horizontal axes 23A and 23B respectively. Control planes such as control planes 16, 17, 18, 19 and 20 may be oriented at any suitable angle relative to body axes 23A, 23B and 23C.

An angler may adjust or tune the performance of an individual lure or swim bait at the time of use to optimize the desired motions according to the existing water conditions. For example, small changes can be made to the positions of the control planes as well as the size and location of weights and hook placement and orientation that will enable the angler to fine-tune the lure to achieve the desired swimming motions. These fine adjustments can easily be made by adjusting the length of the control planes by pulling them out or pushing them in further into the body, or pushing them through farther to the opposite side of the bait.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

We claim:

1. An artificial fishing lure comprising:
a soft lure body having a lifelike profile and longitudinal, vertical and horizontal axes, the lure body comprising:
a first body segment;
a second body segment secured to the first body segment with a flexible joint;
a tail segment secured to the second body segment with a flexible joint; and
one or more damper elements in the joint between the first and second body segments and oriented parallel to the horizontal axis.

2. The artificial lure of claim 1 further comprising:
a first control plane inserted into the first body segment the first control plane oriented coplanar to the longitudinal axis and the vertical axis of the lure body;
a second control plane inserted through the first body segment, the second control plane oriented coplanar to the longitudinal axis and the horizontal axis of the lure body;
a third control plane inserted into the second body segment, the third control plane oriented coplanar to the longitudinal axis of the lure body and the vertical axis of the lure body;
a fourth control plane inserted through the tail segment, the fourth control plane oriented coplanar to the longitudinal axis of the lure body and parallel to the vertical axis of the lure body; and
a fifth control plane inserted through the tail segment of the two or more segments, the fifth control plane oriented coplanar to the longitudinal axis of the lure body and parallel to the horizontal axis of the lure body.

3. The artificial lure of claim 1 wherein the one or more damper elements are pins.

4. The artificial lure of claim 1 wherein the one or more damper elements are bumpers.

5. The artificial lure of claim 1 wherein the one or more damper elements are bars.

6. An artificial fishing lure comprising:
a soft lure body having a lifelike profile and longitudinal, vertical and horizontal axes, the lure body comprising:
a first body segment;
a second body segment secured to the first body segment with a damper joint; and
a tail segment secured to the second body segment with a flexible joint.

7. The artificial lure of claim 6 further comprising:
one or more damper elements in the joint between the first and second body segments and oriented parallel to the horizontal axis.

8. The artificial lure of claim 7 wherein the one or more damper elements are pins.

9. The artificial lure of claim 7 wherein the one or more damper elements are bumpers.

10. The artificial lure of claim 7 wherein the one or more damper elements are bars.
